(19) United States
(12) Patent Application Publication
(10) Pub. No.: US 2014/0208340 A1
(43) Pub. Date: Jul. 24, 2014

(54) DYNAMIC CONTENT RATING MANAGEMENT ACROSS A VARIETY OF TELEVISION INPUT SOURCES

(71) Applicants: Rajesh Poornachandran, Portland, OR (US); Gyan Prakash, Beaverton, OR (US); Ravikiran Chukka, Beaverton, OR (US); Saurabh Dadu, Tigard, OR (US); Kaitlin A. Murphy, Hillsboro, OR (US)

(72) Inventors: Rajesh Poornachandran, Portland, OR (US); Gyan Prakash, Beaverton, OR (US); Ravikiran Chukka, Beaverton, OR (US); Saurabh Dadu, Tigard, OR (US); Kaitlin A. Murphy, Hillsboro, OR (US)

(21) Appl. No.: 13/996,598

(22) PCT Filed: Apr. 18, 2012
(86) PCT No.: PCT/US12/34005

§ 371 Date: Mar. 14, 2014

(51) Int. Cl. H04N 21/454; H04N 21/442

(52) U.S. Cl. CPC H04N 21/4542; H04N 21/44218
USPC 725/10

(57) ABSTRACT

Generally, this disclosure describes a system and method for dynamic content management across a variety of television input sources. The system may include an audience detection module configured to identify a viewer in a viewing area of a display configured to display received media content; a media scanning module configured to determine a media content rating associated with a portion of a media content received from at least one of a local content source and a remote content source; and a media player configured to adapt display of the portion of the received media content based on a policy when the associated media content rating corresponds to inappropriate content for the identified viewer.

### FIELD

This disclosure relates to dynamic content rating management, more particularly dynamic content rating management across a variety of television input sources.

### BACKGROUND

Televisions may display media content received from a number of sources including for example, cable, satellite dish, internet, gaming consoles, DVD/DVR and/or home media sources. Ratings generally are available for content received via cable and/or satellite dish (i.e., broadcast television). Parents and other responsible adults may set parental controls configured to prevent display of media content that may be inappropriate for children. Such parental controls are typically associated with the source of the media content so that the parental controls, if they exist, must be set for each individual source. With such an array of sources, it is difficult to reliably configure the parental controls. Additionally, for some sources, such as peripheral devices (e.g., USB devices, DVD players and computers), parental controls may not exist. Thus, children may be unintentionally exposed to inappropriate content. Further, such parental controls are typically set for a complete content, e.g., a movie, when the inappropriate content may be limited to only a portion of the content.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a system that includes a content management system consistent with various embodiments of the present disclosure;

FIG. 2 illustrates a flowchart of exemplary operations consistent with various embodiments of the present disclosure; and

FIG. 3 illustrates a flowchart of exemplary operations for updating configuration settings consistent with various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure describes a system and method configured to integrate a parental control function so that inappropriate media content from any source is not displayed when children enter and/or are present in an audience. As used herein, “media content” includes audio and/or visual content that may be displayed on, for example, a television. Media content may include, but is not limited to, audio and/or visual content received from cable television providers, satellite television providers, internet sources, gaming consoles, DVD/DVR devices, home media sources and/or other sources (including, e.g., directly connected USB devices). The system and method are configured to detect viewer(s) in a viewing area of a display (e.g., television), identify the detected viewer(s) and to adapt displayed media content based on profile(s) associated with the identified viewer(s). The system and method are configured to periodically and/or continuously detect and identify which viewer(s) are present in order to dynamically adjust the content if the audience changes.

The system and method are further configured to monitor media content to detect inappropriate content for the identified viewer(s) and to respond, based on policy, if inappropriate content is detected. Monitoring may include determining a media content rating associated with a portion of the media content. In some embodiments, monitoring may include determining a media content rating associated with an entire media content (e.g., personal media content). Monitoring may include identifying inappropriate content based on the media content rating, metadata associated with the content and/or pattern matching of audio and/or video content prior to display. Response(s) may include adapting display of the portion of the media content by, for example, blocking, censoring, and/or blipping the inappropriate content, notifying and/or alerting a designated person, and/or providing potentially inappropriate content to a remote service for further processing. Response(s) may further include preventing display of the entire media content.

Thus, a system and method consistent with the present disclosure is configured to dynamically adjust media content based, at least in part, on the audience. Inappropriate content may then be detected, for example, via the content rating, metadata and/or pattern recognition mechanisms in real time. Utilizing the content rating, metadata and/or pattern recognition facilitates implementing a single parental control across a variety of media sources.

Further, the system and method are configured to prevent display of the inappropriate content without preventing display of content that may not be inappropriate. For example, a movie may be generally appropriate for an audience with only a few scenes that are inappropriate for a specific viewer. The system and method consistent with the present disclosure are configured to adapt and/or prevent display of the few scenes when the specific viewer is present so that the movie may be viewed by the audience without concern that the specific viewer will be exposed to inappropriate content.

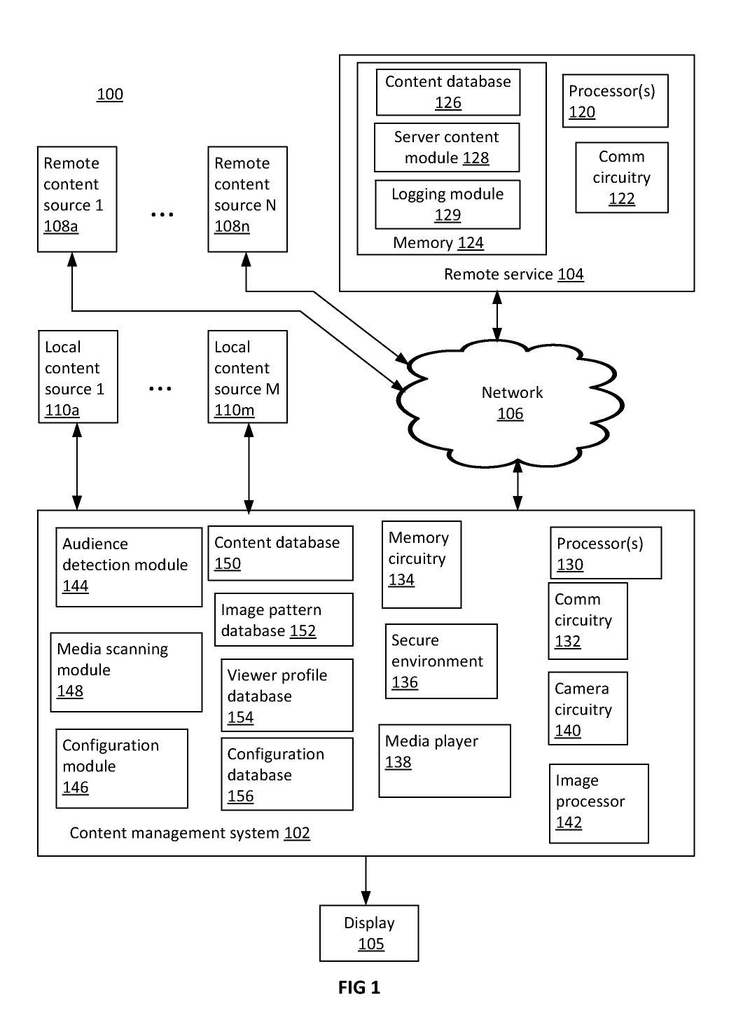

FIG. 1 illustrates a system 100 that includes a content management system 102 consistent with various embodiments of the present disclosure. The system 100 further includes remote service 104, display 105, and network 106. The system 100 may include one or more remote content source(s) 108a . . . , 108n and/or one or more local content source(s) 110a, . . . , 110m. The remote service 104 and/or the remote content source(s) 108a, . . . , 108n are configured to be coupled to content management system 102 by network 106. Remote content source(s) 108a, . . . , 108n may include, but are not limited to, cable television providers, satellite television providers, internet web sites, interactive video games and/or other online content providers. Remote content source(s) 108a, . . . , 108n may be included in remote service 104.

Local content source(s) 110a, . . . , 110m may include, but are not limited to, set-top-boxes, USB flash memories, gaming consoles, computing devices, DVD players, digital video recorders (DVR), WiDi (wireless display from a computing device to, e.g., a television) enabled devices, secure digital (SD) memory cards, portable media players and/or other local sources, The remote content sources 108a, . . . , 108n and the local content sources 110a, . . . , 110m are configured to provide video and/or audio for display on display 105. Display 105 may be included in, for example, a television.

Remote service 104 may include one or more processor(s) 120, communication circuitry 122 and memory 124. Remote service 104 may correspond to one or more servers in a plurality of servers, i.e., may be in the cloud. Processor(s) 120 are configured to perform operations associated with system 100 and server content module 128. Communication circuitry 122 is configured to communicate, wired and/or wirelessly, with content management system 102 via network 106, using one or more communication protocols, as described herein. The communication protocols may include, but are not limited to, NFC, RFID, Wi-Fi, Bluetooth, 3G, 4G and/or some other communication protocol.

Memory 124 is configured to store content database 126, server content module 128 and logging module 129. Content database 126 may include metadata associated with media content available from remote content source(s) 108a, . . . , 108n and/or local content source(s) 110a, . . . , 110m. Metadata associated with media content available from local content source(s) 110a, . . . , 110m may be uploaded to remote service 104 from content management system 102, e.g., as backup storage. Content database 126 may include patterns related to potentially inappropriate media content. The metadata and/or patterns may be categorized according to a content rating. For example, content rating may correspond to an age and/or age range of a viewer. In another example, the content rating may be related to duration and/or intensity of scenes, e.g., violence, that may be inappropriate for some viewers. The metadata, patterns and/or content ratings may be associated with a unique content identifier and/or a sequence indicator.

Server content module 128 is configured to manage operations of the remote service 104 related to appropriateness of media content. Server content module 128 is configured to receive requests and/or data from content management system 102 and to provide response(s) to the content management system 102. For example, server content module 128 may receive a request for metadata and/or pattern(s) related to potentially inappropriate content from the content management system 102 via network 106. In another example, server content module 128 may receive a request for analysis of at least a portion of potentially inappropriate media content from the content management system 102. The request may include the portion of potentially inappropriate media content.

Logging module 129 is configured to log (i.e., store) a listing of transactions associated with content management system 102. For example, logging module 129 may log each access to remote service 104 by content management system 102 and/or other similar content management system(s). Each log entry may include a content management system identifier, a content identifier and/or a type of access indicator. For example, the type of access indicator may correspond to a request for metadata, a request for further analysis and/or other types of access.

For example, the remote service 104 and server content module 128 may receive an alert from content management system 102 related to inappropriate content in at least a portion of an identified media content. Logging module 129 is configured to log the alert. The identified media content may be a movie and may be identified by an associated unique identifier. The server content module 128 is configured to store an inappropriate content indicator (e.g., inappropriate content flag) associated with the media content identifier in the content database 126. The inappropriate content indicator may include a content rating associated with the inappropriate content flag and may also include a sequential indicator corresponding to a location (e.g., frame number, time stamp) of the inappropriate content in the media content. In other words, the content database 126 may include records related to potentially inappropriate content. Each record may include a content identifier, an inappropriate content flag, an associated content rating, a starting sequential indicator corresponding to the inappropriate content, a duration indicator of the inappropriate content and/or an ending sequential indicator. This data may be utilized by subsequent users to identify inappropriate content prior to displaying the media content including the inappropriate content.

Content management system 102 is configured to monitor video and/or audio media content from any remote source 108a, . . . , 108n and/or any local source 110a, . . . , 110n. Content management system 102 is further configured to allow, limit or prevent display of the monitored content on display 105 based at least in part on viewer profiles of viewer(s) in the audience and the content rating(s) associated with the content. Content management system 102 is configured to adapt display of portions of media content based on policy when the associated media content rating for the portion corresponds to inappropriate content for an identified viewer.

Content management system 102 includes one or more processor(s) 130, communication circuitry 132, memory 134 and secure environment 136. Processor(s) 130 are configured to perform one or more operations associated with content management system 102. Communication circuitry 132 is configured to couple the content management system 102 to remote service 104, via network 106. Communication circuitry 132 may be configured to couple the content management system 102 to remote source(s) 108a, . . . , 108n via network 106 and/or to couple the content management system 102 to local content sources 110a, . . . , 110m. Communication circuitry 132 is configured to communicate using one or more communication protocols, as described herein.

Memory 134 is configured to store one or more database(s) and may be configured to store one or more modules associated with dynamic content management, as described herein. Secure environment 136 is configured to provide a secure execution and storage environment. Access to data stored in the secure environment 136 may be limited through, for example, password protection. For example, a configuration database 156, configuration module 146 and/or other database(s) and module(s) may be stored in the secure environment 136. The secure environment 136 is configured to provide a tamper-proof execution environment that may not be visible to host processor(s) 130. For example, media player 138 may be configured to be executed in the secure environment 136.

Content management system 102 includes camera circuitry 140, image processor 142, audience detection module 144, configuration module 146, media scanning module 148, and media player 138. Content management system 102 may include a plurality of databases including, but not limited to, content database 150, image pattern database 152, viewer profile database 154 and configuration database 156.

Camera circuitry 140 is configured to capture one or more audience images of a viewing area of display 105. Camera circuitry 140 may include one or more lenses and associated image sensors configured to capture the audience image(s) and to convert the captured audience image(s) into corresponding audience image data. Camera circuitry 140 may then provide the audience image data to audience detection module 144. Camera circuitry 140 may be configured to capture a depth dimension with the captured audience image(s). The depth dimension is configured to prevent a viewer from successfully using a photograph to enable viewing of content with a content rating inappropriate for that viewer.

Audience detection module 144 is configured to receive audience image data from camera circuitry 140. Audience detection module 144 is configured to analyze the received audience image data in order to determine whether viewer(s) are present and to identify such viewer(s) using, for example, viewer profile database 154. Viewer profile database 154 may include reference viewer image data corresponding to each viewer in a household and/or other frequently present viewers. Viewer profile database may include a unique viewer identifier associated with each reference viewer image. Audience detection module 144 may compare audience image data to reference viewer image data to identify viewer(s) present in the audience.

Viewer profile database 154 may include viewer profile data associated with each viewer identifier. Viewer profile data is configured to include content rating(s) associated with each viewer identifier. If viewer(s) are present that are unknown (no match with reference viewer image data), a default identifier corresponding to unknown viewer may be returned. Viewer profile database 154 may then include a default content rating associated with unknown viewers. An authenticated user may set the default content rating, as described herein.

Thus, audience detection 144 module is configured to detect the presence of viewer(s) and to identify the detected viewer(s) based on reference viewer image data stored in the user profile database 154. The user profile database 154 is further configured to store a unique viewer identifier associated with each reference viewer image and a content rating associated with the unique viewer identifier.

Configuration module 146 is configured to allow an authorized user to set policy for the content management system 102. Policy settings include desired effect if a viewer with an associated profile that conflicts with a content rating of currently (or soon to be) displayed content is present and/or enters the viewing area. Desired effects include but are not limited to blocking, blipping, blanking and/or otherwise censoring the content, providing the content to the remote service 104 for further processing, logging and/or storage, and/or alerting the content management system 102. Blocking may include preventing display of content by skipping the frames that include the content. Blipping may include replacing inappropriate audio with a tone (e.g., beep) or with some other sound. Blanking may include replacing inappropriate content by a blank screen. Such policy settings may be stored in configuration database 156.

Media scanning module 148 is configured to monitor media content received from local and remote content source(s) 108a, . . . , 108n; 110a, . . . , 110m in order to detect inappropriate content. Media scanning module 148 may determine a content rating of received content prior to display of the received content by media player 138.

For example, the content rating may be determined based on local rating data that may be stored in content database 150 and/or remote rating data retrieved from remote service 104. The rating data may include but is not limited to metadata, closed captioning, and/or previously acquired rating data. Metadata may include media content metadata based on an MPEG-7 standard, as described herein. Such metadata may include a frame-by-frame content rating. The media scanning module 148 may then be configured to detect and/or communicate the presence of inappropriate content based, at least in part, on one or more frame-identifiers. Closed captioning may be interpreted by media scanning module 148 prior to display of associated content. Words inappropriate for some viewers may then be blipped. The closed captioning may likewise be blanked out. Previously acquired rating data may be stored in local content database 150 and in remote service content database 126 and is similar to metadata. In other words, previously acquired rating data may be associated with frames that include potentially inappropriate content. Thus, in this example, content ratings may be included in data associated with one or more frames. Frame identifiers may then be utilized by, e.g., media player 138, to prevent display of the frames.

In another example, the media scanning module 148 may be configured to determine the content rating by analyzing received and/or scheduled media content using, for example, image processor 142. In this example, the media scanning module 148 may be configured to execute in the secure environment 136 to ensure content security. Image pattern database 152 may include image patterns corresponding to content ratings of content that may be inappropriate for some viewers. The image patterns stored in the image pattern database 152 may include previously analyzed media content deemed to be inappropriate for at least some viewers. The image pattern database 152 may include image patterns purposely generated that include content that may be inappropriate for some viewers. The image pattern database 152 may include a content rating associated with each stored image pattern.

These image patterns may illustrate for example a variety of violent scenes or portions of scenes. These violent scenes may then be used as reference scenes for comparison with received image data prior to display. The received image data corresponds to one or more frames and/or scenes of media content received from local 108a, . . . , 108n and/or remote 110a, . . . , 110m content sources. The image processor 142 may then be configured to compare images retrieved from the image pattern database 152 and/or remote content database 126 with received image data. The media scanning module 148 may be configured to determine a content rating of one or more frames of the received image data based on the comparison. Such image processing may be performed in real time by the image processor 142 prior to display of the media content. The image processing may result in a delay of a few seconds between receipt of the media content and display of adapted (e.g., censored) content.

In another example, an authorized user may set a content rating associated with local source content. For example, personal content, including home movies, amateur video and/or personal photographs may be provided an associated personal content rating by the authorized user. The personal content and associated personal content rating may be stored in content database 150. In some embodiments, the personal content may be stored in secure environment 136 and/or in personal protected storage. The associated personal content rating may be configured to permit display of the personal content to a selected audience. For example, for a content rating related to an age or age range, the personal content may be provided a personal content rating corresponding to an age range that is configured to conflict with all unknown viewers and most of the known viewers included in the viewer profile database 154 (e.g., age over 100 years old). In this manner, display of personal content may be limited using a system and method consistent with the present disclosure.

Media player 138 is configured to process media content for display on display 105. Media player 138 may include a smart TV content player module, an embedded media player and/or a media player application. Media player 138 is configured to adapt displayed media content according to the current policy and identified viewer(s) if the associated media content rating corresponds to inappropriate content for identified viewer(s). In other words, media player 138 is configured to display content appropriate for a current audience based on the media content rating, the current policy and identified viewer(s). Media player 138 may be configured to indicate tampering during play back mode thus ensuring the media player's integrity or alerting if its integrity is questionable.

Thus, content management system 102 is configured to identify viewers who are present or enter a viewing area during display of media content on display 105. The content management system 102 is further configured to allow an authorized user to set current policy. Current policy is configured to associate allowable content ratings with viewers. The media scanning module 148 may then monitor content (for example, frame by frame) to determine a content rating. Based on the content rating, the current policy and the viewers present, the media player is configured to adapt each portion of received media content to play media content appropriate for the audience.

It should be noted that existing content rating systems generally apply/assign a rating to an entire media content offering, e.g., a movie. Most media content generally includes a plurality of portions that may correspond to a variety of content ratings. A content management system consistent with the present disclosure is configured to detect individual portions of media content that may not be appropriate for some viewers. The inappropriate content may then be adapted (e.g., censored) while the remainder of the media content may be viewed.

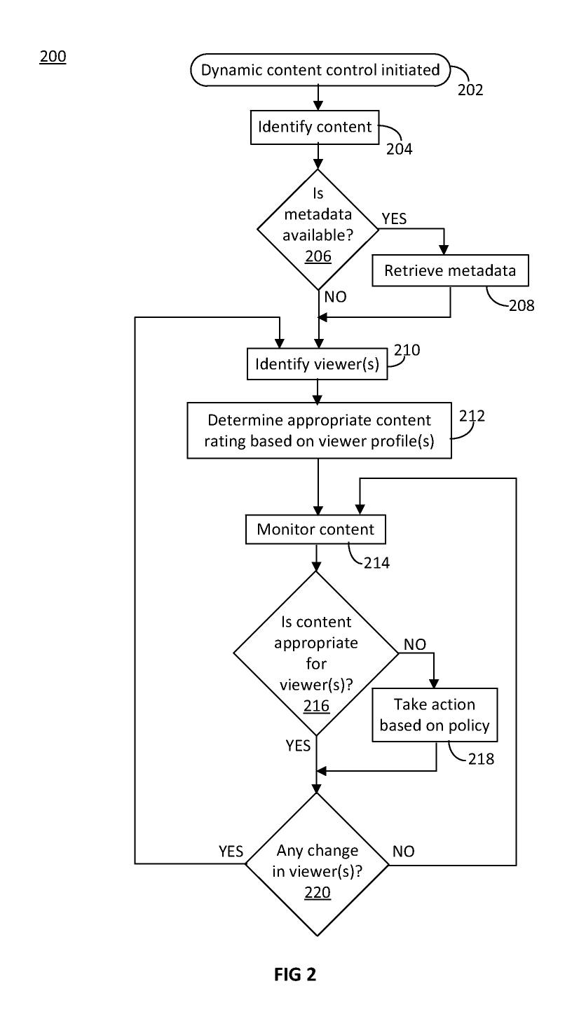

FIG. 2 illustrates an flowchart 200 of exemplary operations consistent with an embodiment of the present disclosure. The operations may be performed, for example, by content management system 102. In particular, flowchart 200 depicts exemplary operations configured to adapt display of a portion of media content to prevent or limit display of inappropriate content from any source.

Operations of flow chart 200 may begin with initiation 202 of dynamic content control. For example, dynamic content control may be initiated by a user authorized to set policy, as described herein. In another example, dynamic content control may be enabled by default and may be disabled by the authorized user. Content may be identified at operation 204. For example, a unique identifier associated with the content may be determined. The content identifier may be used to determine whether content data is available for the identified content. Content data includes results of previous analyses of the content and/or metadata associated with the content.

Whether metadata is available for the identified content may be determined at operation 206. Metadata corresponds to content rating data that may be available, for example, frame by frame. If metadata is available, the metadata may be retrieved at operation 208. For example, the metadata may be retrieved from a remote service, e.g., remote service 104. In another example, metadata may be retrieved from local content data.

Operation 210 may include identifying viewer(s). For example, viewer(s) may be identified based on captured images of the viewing area. An appropriate content rating may be determined based on viewer profile(s) at operation 212. For example, a threshold content rating may be determined that corresponds to the viewer with a lowest or highest appropriate content rating.

Operation 214 includes monitoring content. If metadata is available, metadata may be used to monitor content, as described herein. If metadata or similar data is not available for the identified content, then monitoring content may include image processing the received content and performing pattern recognition to detect content that may violate current policy, e.g., content whose associated content rating may conflict with a viewer content rating.

Whether the received content is appropriate for the viewer(s) may be determined at operation 216. If the content is not appropriate, action may be taken based on policy at operation 218. For example, actions may include blocking, censoring and/or blipping the inappropriate content, notifying and/or alerting a designated person and/or providing potentially inappropriate content to a remote service for further processing.

Whether there has been any change in viewer(s) may be determined at operation 220. If there has been no change in viewers(s) program flow may proceed to operation 214, monitoring content. If there has been a change in viewers, program flow may proceed to operation 210, identify users.

Thus, an audience and media content from any source may be monitored and content inappropriate for any identified viewer in the audience may be adapted (e.g., censored or prevented) for display. The operations of flowchart 200 are configured to monitor content in real time, and automatically adjust to audience changes and content rating changes associated with portions of the media content.

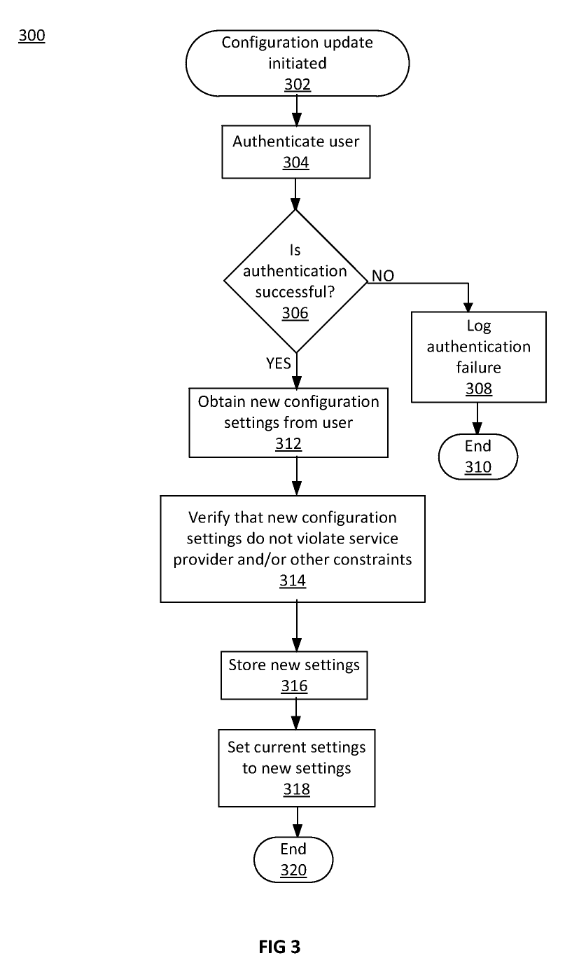

FIG. 3 illustrates an flowchart 300 of exemplary operations consistent with an embodiment of the present disclosure. The operations may be performed, for example, by content management system 102, e.g., configuration module 146. In particular, flowchart 300 depicts exemplary operations configured to allow an authorized user to set content rating(s) for viewer(s) and to input configuration setting(s) for content management system 102.

The operations of flow chart 300 may begin with initiating 302 a configuration update. Operation 304 may include authenticating the user. For example, the configuration data may be stored and processed in a secure environment, e.g., secure environment 136, with password protected access. A user attempting to access the configuration database may be authenticated using a password.

Whether the authentication was successful may be determined at operation 306. If the authentication was not successful, an authentication failure may be logged at operation 308 and program flow may end at operation 310. Logging the authentication failure is configured to provide notice to an authorized user of the failed authentication attempt. In some embodiments, successful authentication may also be logged. If the authentication is successful, new configuration settings may be obtained at operation 312. For example, the authorized user may add a viewer and an associated content rating. In another example, the authorized user may adjust a content rating for an existing viewer. In another example, the authorized user may adjust content parameters associated with setting a content rating. Operation 314 includes verifying that new configuration settings do not violate service provider or other constraints associated with content. For example, service provider(s) and/or content distributor(s) may emphasize restrictions that a user may not violate. For example, a user may prevented from changing a content rating of a movie rented online from, for example, an R-rating to a PG-13 rating. In another example, an authorized user may not be permitted to associate an allowable content rating equivalent to an R-rating to a child below a certain age. Operation 316 includes storing the new settings. The current settings may be set to the new settings at operation 318. In some embodiments, the authorized user may configure the new settings to take effect based on the detected audience, e.g., only if a specified viewer is detected. Program flow may end at operation 320.

Thus, an authorized user may assign content rating(s) to one or more viewer(s). The authorized user may further set policy that defines a response of content management system to inappropriate content for an identified viewer. The response may be initiated by receipt of inappropriate content from any source, remote or local.

While FIGS. 2 and 3 illustrate various operations according one embodiment, it is to be understood that not all of the operations depicted in FIGS. 2 and 3 are necessary for other embodiments. Indeed, it is fully contemplated herein that in other embodiments of the present disclosure, the operations depicted in FIGS. 2 and 3 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical locations. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device. The storage medium may be non-transitory.

Metadata related to media content may comply or be compatible with one or more MPEG-7 standards published by the International Standards Organization (ISO) and/or the International Electrotechnical Commission (IEC), including ISO/IEC 15938, titled: Information Technology—Multimedia Content Description Interface, Part 1—Systems, published in 2002, through Part 12—Query Format, published 2008, and/or later versions of these standards.

Content management system 102 may be configured to communicate with network 106, remote service 104 and/or remote content source(s) 108a, . . . , 108n using a variety of communication protocols. The communications protocols may include but are not limited to wireless communications protocols, such as NFC, RFID, Wi-Fi, Bluetooth, 3G, 4G and/or other communication protocols. The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The NFC and/or RFID communication signal and/or protocol may comply or be compatible with one or more NFC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006, titled: ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PHY) Specifications for Wireless Personal Area Networks (W Pans)”, published in 2005, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 4G protocol may comply or be compatible with IMT standard published by the ITU, titled “IMT-Advanced”, published in 2008, and/or later versions of this standard.

For example, network 106 may comprise a packet switched network. Content management system 102 may be capable of communicating with the remote service 104 and/or remote content source(s) 108a, . . . , 108n using a selected packet switched network communications protocol. One exemplary communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard. Alternatively or additionally, content management system 102 may be capable of communicating with the remote service 104 and/or remote content source(s) 108a, . . . , 108n, using an X.25 communications protocol. The X.25 communications protocol may comply or be compatible with a standard promulgated by the International Telecommunication Union-Telecommunication Standardization Sector (ITU-T). Alternatively or additionally, content management system 102 may be capable of communicating with the remote service 104 and/or remote content source(s) 108a, . . . , 108n, using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, content management system 102 may be capable of communicating with the remote service 104 and/or remote content source(s) 108a, . . . , 108n, using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein.

“Circuitry”, as used in any embodiment herein, may comprise, for example, singly or in any combination, hardwired circuitry, programmable circuitry, state machine circuitry, and/or firmware that stores instructions executed by programmable circuitry. An app may be embodied as code or instructions which may be executed on programmable circuitry such as a host processor or other programmable circuitry. A module, as used in any embodiment herein, may be embodied as circuitry. The circuitry may be embodied as an integrated circuit, such as an integrated circuit chip.

Thus, the present disclosure provides an apparatus, method and system for dynamic content rating management across a variety of television content sources. The content sources may be remote or local. Viewers may be identified and the audience may be monitored to detect changes in viewer(s). An identified viewer may have an associated content rating. Portions of media content that may be inappropriate for an identified viewer with an associated viewer content rating may be adapted (e.g., censored) for display and/or other action(s) may be taken based on policy. Content rating of received content may be determined based on, for example, metadata and/or via pattern recognition techniques.

According to one aspect there is provided an apparatus. The apparatus may include an audience detection module configured to identify a viewer in a viewing area of a display configured to display received media content; a media scanning module configured to determine a media content rating associated with a portion of a media content received from at least one of a local content source and a remote content source; and a media player configured to adapt display of the portion of the received media content based on a policy when the associated media content rating corresponds to inappropriate content for the identified viewer.

Another example apparatus includes the forgoing components and further includes memory circuitry configured to store a respective viewer content rating for each of a plurality of viewers, the respective viewer content rating corresponding to appropriate media content for the respective viewer.

Another example apparatus includes the forgoing components and the local source is one of a set-top-box, a USB flash memory, a gaming console, a computing device, a DVD player, a digital video recorder (DVR), a wireless display (WiDi) enabled device, a secure digital (SD) memory card, a portable media player and other local sources.

Another example apparatus includes the forgoing components and the remote source is one of a cable television provider, a satellite television provider, an internet web site, an interactive video game and other online content providers.

Another example apparatus includes the forgoing components and the media scanning module is configured to determine the media content rating based, at least in part, on metadata associated with the portion of the received media content, the metadata related to the media content rating.

Another example apparatus includes the forgoing components and the media scanning module is configured to compare the portion of the received media content to reference image data comprising inappropriate content to determine the media content rating.

Another example apparatus includes the forgoing components and the media scanning module is configured to compare the portion of the received media content to reference image data in real-time after receipt of the received media content and prior to display of the portion of the media content.

Another example apparatus includes the forgoing components and the media content is personal content received from the local content source and the media scanning module is configured to determine the media content rating based on an associated personal content rating stored in a content database.

According to another aspect there is provided a system. The system may include an apparatus and a remote service. The system may include an apparatus including an audience detection module configured to identify a viewer in a viewing area of a display configured to display received media content, a media scanning module configured to determine a media content rating associated with a portion of a media content received from at least one of a local content source and a remote content source, and a media player configured to adapt display of the portion of the received media content based on a policy when the associated media content rating corresponds to inappropriate content for the identified viewer; and a remote service configured to communicate with the apparatus via a network, the remote service comprising a processor, communication circuitry coupled to the processor, and a remote service memory.

Another example system includes the forgoing components and the apparatus further includes apparatus memory circuitry configured to store a respective viewer content rating for each of a plurality of viewers, the respective viewer content rating corresponding to appropriate media content for the respective viewer.

Another example system includes the forgoing components and the apparatus is configured to provide the portion of the received media content to the remote service for analysis based on the policy if the associated media content rating corresponds to inappropriate content.

Another example system includes the forgoing components and the media scanning module is configured to determine the media content rating based, at least in part, on metadata associated with the portion of the received media content, the metadata related to the media content rating and wherein the metadata is stored in remote service memory and the apparatus is configured to retrieve the metadata from the remote service.

Another example system includes the forgoing components and the media scanning module is configured to compare the portion of the received media content to reference image data comprising inappropriate content to determine the media content rating and wherein the reference image data is stored in remote service memory and the apparatus is configured to retrieve the reference image data from the remote service.

Another example system includes the forgoing components and the media content is personal content received from the local content source and the media scanning module is configured to determine the media content rating based on an associated personal content rating stored in a content database.

According to another aspect there is provided a method. The method may include identifying a viewer in a viewing area of a display configured to display received media content; determining a media content rating associated with a portion of a media content received from at least one of a local content source and a remote content source; and adapting display of the portion of the received media content based on a policy when the associated media content rating corresponds to inappropriate content for the identified viewer.

Another example method includes the forgoing operations and further includes storing a respective viewer content rating for each of a plurality of viewers, the respective viewer content rating corresponding to appropriate media content for the respective viewer.

Another example method includes the forgoing operations and the local source is one of a set-top-box, a USB flash memory, a gaming console, a computing device, a DVD player, a digital video recorder (DVR), a wireless display (WiDi) enabled device, a secure digital (SD) memory card, a portable media player and other local sources.

Another example method includes the forgoing operations and the remote source is one of a cable television provider, a satellite television provider, an internet web site, an interactive video game and other online content providers.

Another example method includes the forgoing operations and the determining the media content rating is based, at least in part, on metadata associated with the portion of the received media content, the metadata related to the media content rating.

Another example method includes the forgoing operations and the determining the media content rating includes comparing the portion of the received media content to reference image data comprising inappropriate content to determine the media content rating.

Another example method includes the forgoing operations and the comparing the portion of the received media content to reference image data is performed in real-time after receipt of the received media content and prior to display of the portion of the media content.

Another example method includes the forgoing operations and the media content is personal content received from the local content source and the media content rating is determined based on an associated personal content rating stored in a content database.

According to another aspect there is provided a system. The system may include one or more storage mediums having stored thereon, individually or in combination, instructions that when executed by one or more processors result in the following operations comprising: identifying a viewer in a viewing area of a display configured to display received media content; determining a media content rating associated with a portion of a media content received from at least one of a local content source and a remote content source; and adapting display of the portion of the received media content based on a policy when the associated media content rating corresponds to inappropriate content for the identified viewer.

Another example system includes instructions that when executed by one or more processors result in the forgoing operations and also includes storing a respective viewer content rating for each of a plurality of viewers, the respective viewer content rating corresponding to appropriate media content for the respective viewer.

Another example system includes instructions that when executed by one or more processors result in the forgoing operations and includes that the local source is one of a set-top-box, a USB flash memory, a gaming console, a computing device, a DVD player, a digital video recorder (DVR), a wireless display (WiDi) enabled device, a secure digital (SD) memory card, a portable media player and other local sources.

Another example system includes instructions that when executed by one or more processors result in the forgoing operations and includes that the remote source is one of a cable television provider, a satellite television provider, an internet web site, an interactive video game and other online content providers.

Another example system includes instructions that when executed by one or more processors result in the forgoing operations and includes that the determining the media content rating is based, at least in part, on metadata associated with the portion of the received media content, the metadata related to the media content rating.

Another example system includes instructions that when executed by one or more processors result in the forgoing operations and includes that the determining the media content rating comprises comparing the portion of the received media content to reference image data comprising inappropriate content to determine the media content rating.

Another example system includes instructions that when executed by one or more processors result in the forgoing operations and includes that the comparing the portion of the received media content to reference image data is performed in real-time after receipt of the received media content and prior to display of the portion of the media content.

Another example system includes instructions that when executed by one or more processors result in the forgoing operations and includes that the media content is personal content received from the local content source and the media content rating is determined based on an associated personal content rating stored in a content database.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-23. (canceled)

24. An apparatus comprising:
an audience detection module configured to identify a viewer in a viewing area of a display configured to display received media content;
a media scanning module configured to determine a media content rating associated with a portion of a media content received from at least one of a local content source and a remote content source; and
a media player configured to adapt display of the portion of the received media content based on a policy when the associated media content rating corresponds to inappropriate content for the identified viewer.

25. The apparatus of claim 24, further comprising:
memory circuitry configured to store a respective viewer content rating for each of a plurality of viewers, the respective viewer content rating corresponding to appropriate media content for the respective viewer.

26. The apparatus of claim 24, wherein the local source is one of a set-top-box, a USB flash memory, a gaming console, a computing device, a DVD player, a digital video recorder (DVR), a wireless display (WiDi) enabled device, a secure digital (SD) memory card, a portable media player and other local sources.

27. The apparatus of claim 24, wherein the remote source is one of a cable television provider, a satellite television provider, an internet web site, an interactive video game and other online content providers.

28. The apparatus of claim 24, wherein the media scanning module is configured to determine the media content rating based, at least in part, on metadata associated with the portion of the received media content, the metadata related to the media content rating.

29. The apparatus of claim 24, wherein the media scanning module is configured to compare the portion of the received media content to reference image data comprising inappropriate content to determine the media content rating.

30. The apparatus of claim 29, wherein the media scanning module is configured to compare the portion of the received media content to reference image data in real-time after receipt of the received media content and prior to display of the portion of the media content.

31. The apparatus of claim 24, wherein the media content is personal content received from the local content source and the media scanning module is configured to determine the media content rating based on an associated personal content rating stored in a content database.

32. A system, comprising:
an apparatus comprising:
an audience detection module configured to identify a viewer in a viewing area of a display configured to display received media content,
a media scanning module configured to determine a media content rating associated with a portion of a media content received from at least one of a local content source and a remote content source, and
a media player configured to adapt display of the portion of the received media content based on a policy when the associated media content rating corresponds to inappropriate content for the identified viewer; and
a remote service configured to communicate with the apparatus via a network, the remote service comprising a processor, communication circuitry coupled to the processor, and a remote service memory.

33. The system of claim 32, wherein the apparatus further comprises apparatus memory circuitry configured to store a respective viewer content rating for each of a plurality of viewers, the respective viewer content rating corresponding to appropriate media content for the respective viewer.

34. The system of claim 32, wherein the apparatus is configured to provide the portion of the received media content to the remote service for analysis based on the policy if the associated media content rating corresponds to inappropriate content.

35. The system of claim 32, wherein the media scanning module is configured to determine the media content rating based, at least in part, on metadata associated with the portion of the received media content, the metadata related to the media content rating and wherein the metadata is stored in remote service memory and the apparatus is configured to retrieve the metadata from the remote service.

36. The system of claim 32, wherein the media scanning module is configured to compare the portion of the received media content to reference image data comprising inappropriate content to determine the media content rating and wherein the reference image data is stored in remote service memory and the apparatus is configured to retrieve the reference image data from the remote service.

37. The system of claim 32, wherein the media content is personal content received from the local content source and the media scanning module is configured to determine the media content rating based on an associated personal content rating stored in a content database.

38. A method comprising:
identifying a viewer in a viewing area of a display configured to display received media content;
determining a media content rating associated with a portion of a media content received from at least one of a local content source and a remote content source; and
adapting display of the portion of the received media content based on a policy when the associated media content rating corresponds to inappropriate content for the identified viewer.

39. The method of claim 38, further comprising:
storing a respective viewer content rating for each of a plurality of viewers, the respective viewer content rating corresponding to appropriate media content for the respective viewer.

40. The method of claim 38, wherein the local source is one of a set-top-box, a USB flash memory, a gaming console, a computing device, a DVD player, a digital video recorder (DVR), a wireless display (WiDi) enabled device, a secure digital (SD) memory card, a portable media player and other local sources.

41. The method of claim 38, wherein the remote source is one of a cable television provider, a satellite television provider, an internet web site, an interactive video game and other online content providers.

42. The method of claim 38, wherein the determining the media content rating is based, at least in part, on metadata associated with the portion of the received media content, the metadata related to the media content rating.

43. The method of claim 38, wherein the determining the media content rating comprises comparing the portion of the received media content to reference image data comprising inappropriate content to determine the media content rating.

44. The method of claim 43, wherein the comparing the portion of the received media content to reference image data is performed in real-time after receipt of the received media content and prior to display of the portion of the media content.

45. The method of claim 38, wherein the media content is personal content received from the local content source and the media content rating is determined based on an associated personal content rating stored in a content database.

46. A system comprising one or more storage mediums having stored thereon, individually or in combination, instructions that when executed by one or more processors result in the following operations comprising:
identifying a viewer in a viewing area of a display configured to display received media content;
determining a media content rating associated with a portion of a media content received from at least one of a local content source and a remote content source; and
adapting display of the portion of the received media content based on a policy when the associated media content rating corresponds to inappropriate content for the identified viewer.

47. The system of claim 46, wherein the instructions that when executed by one or more processors results in the following additional operations:
storing a respective viewer content rating for each of a plurality of viewers, the respective viewer content rating corresponding to appropriate media content for the respective viewer.

48. The system of claim 46, wherein the local source is one of a set-top-box, a USB flash memory, a gaming console, a computing device, a DVD player, a digital video recorder (DVR), a wireless display (WiDi) enabled device, a secure digital (SD) memory card, a portable media player and other local sources.

49. The system of claim 46, wherein the remote source is one of a cable television provider, a satellite television provider, an internet web site, an interactive video game and other online content providers.

50. The system of claim 46, wherein the determining the media content rating is based, at least in part, on metadata associated with the portion of the received media content, the metadata related to the media content rating.

51. The system of claim 46, wherein the determining the media content rating comprises comparing the portion of the received media content to reference image data comprising inappropriate content to determine the media content rating.

52. The system of claim 46, wherein the comparing the portion of the received media content to reference image data is performed in real-time after receipt of the received media content and prior to display of the portion of the media content.

53. The system of claim 46, wherein the media content is personal content received from the local content source and the media content rating is determined based on an associated personal content rating stored in a content database.
